(19) United States
(12) Patent Application Publication
(10) Pub. No.: US 2025/0205016 A1
(43) Pub. Date: Jun. 26, 2025

(54) DENTAL MATERIALS USING RIGID POLYAMIDE

(71) Applicant: Bixby International Corporation, Newburyport, MA (US)

(72) Inventors: Tim Glowik, Danvers, MA (US); Rick Bass, Freemont, NH (US); Marc Gagnon, Exeter, NH (US)

(73) Assignee: Bixby International Corporation, Newburyport, MA (US)

(21) Appl. No.: 18/846,634

(22) PCT Filed: Oct. 19, 2022
(86) PCT No.: PCT/US2022/078366

§ 371 Date: Sep. 12, 2024

Related U.S. Application Data
(60) Provisional application No. 63/321,454, filed on Mar. 18, 2022.

(51) Int. Cl. A61C 7/08; C08L 77/00

(52) U.S. Cl. CPC A61C 7/08; C08L 77/00; A61C 2201/00; C08L 2203/02

(57) ABSTRACT

A dental aligner includes a framework made of a monolayer of a rigid polyamide blended with elastomeric polyether block amide copolymer.

### CROSS REFERENCE TO RELATED APPLICATIONS

This application claims benefit from U.S. Provisional Patent Application Ser. No. 63/321,454, filed Mar. 18, 2022, which is incorporated by reference in its entirety.

### BACKGROUND OF THE INVENTION

The present invention relates generally to dental materials, and more particularly to dental materials using rigid polyamide.

In general, orthodontic procedures typically involve repositioning a patient's teeth to a desired arrangement in order to correct malocclusions and/or improve aesthetics. To achieve these objectives, orthodontic appliances such as braces, retainers, shell aligners, and the like can be applied to the patient's teeth by an orthodontic practitioner. The appliance is configured to exert force on one or more teeth in order to effect desired tooth movements. The application of force can be periodically adjusted by the practitioner (e.g., by altering the appliance or using different types of appliances) in order to incrementally reposition the teeth to a desired arrangement.

Clear aligners, also called invisible aligners, are a type of orthodontic treatment that corrects misaligned or crooked teeth. They are a virtually invisible and removable alternative to braces designed around convenience and flexibility. Aligner trays are custom-made for every patient, depending on the severity of teeth misalignment (malocclusion).

### BRIEF SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a composition including a rigid polyamide blended with elastomeric polyether block amide copolymer.

In another aspect, the invention features a dental aligner including a first rigid polyamide layer, a polyether block amide (PEBA) layer, and a second rigid polyamide layer.

In still another aspect, the invention features a dental aligner including a framework made of a monolayer of a rigid polyamide blended with elastomeric polyether block amide copolymer, the framework having an anterior labial wall, and a posterior lingual wall, which walls are substantially parallel to each other and are connected by a bottom occlusal wall, the occlusal wall being substantially perpendicular to the labial and lingual walls in such a way that the framework has a U-shaped cross section in any vertical plane, wherein the shell is accommodated between the labial, lingual and occlusal walls of the framework, and wherein the shell is anchored thereon by way of anchoring means which are formed in the framework and the shell and having holes going therethrough from side to side between an internal surface of the occlusal wall on which rests the shell and an external surface of the occlusal wall.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE SEVERAL VIEWS OF THE DRAWING

These and other features, aspects, and advantages of the present invention will become better understood with reference to the following description, appended claims, and accompanying drawings where:

FIGS. 1A, 1B and 1C illustrate an exemplary orthodontic appliance.

FIG. 2 is a table.

FIG. 3 is a table.

FIG. 4 illustrates an exemplary invisible aligner framework.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used herein, the term “polymer” refers to a molecule composed of repeating structural units connected by covalent chemical bonds often characterized by a substantial number of repeating units (e.g., equal to or greater than 10 repeating units and often equal to or greater than 50 repeating units and often equal to or greater than 100 repeating units) and a high molecular weight (e.g. greater than or equal to 50,000 Da). Polymers are commonly the polymerization product of one or more monomer precursors. The term polymer includes homopolymers, or polymers consisting essentially of a single repeating monomer subunit. The term polymer also includes copolymers which are formed when two or more different types of monomers are linked in the same polymer. Copolymers may include two or more monomer subunits, and include random, block, alternating, segmented, grafted, tapered and other copolymers.

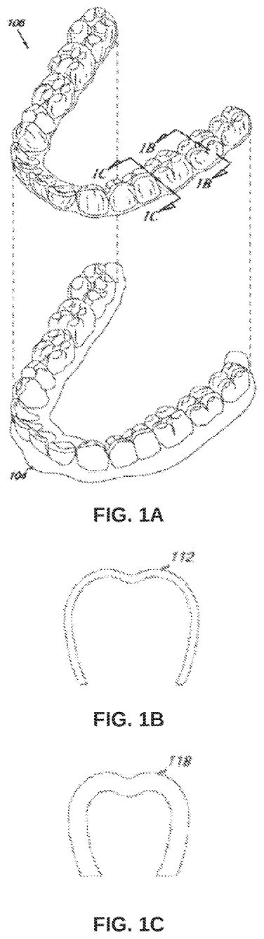

In FIG. 1A, an exemplary orthodontic appliance 106, sometimes referred to as an “invisible aligner” or “dental aligner,” and jaw 104 including a patient's teeth are illustrated. FIG. 1B illustrates orthodontic appliance cross-section 112 as taken along line 1B-1B of FIG. 1A, while FIG. 1C illustrates orthodontic appliance cross-section 118 as taken along line 1C-1C of FIG. 1A. The orthodontic appliance 106 may be designed to fit over a number of teeth present in an upper or lower jaw. As illustrated, the orthodontic appliance has a U-shaped cross-section to form one or more cavities for placement of a patient's teeth therein.

A dental aligner, such as orthodontic appliance 106, typically includes a framework that is made of a rigid synthetic material and supports a shell made of thermoformable material. The framework includes an anterior wall, which is referred to as the labial wall, and a posterior wall, which is referred to as the lingual wall. The walls are substantially parallel to each other and are connected by a bottom wall, which is referred to as the occlusal wall, the latter being substantially perpendicular to both the labial wall and the lingual wall in such a way that the framework has a U-shaped cross section in any vertical plane. The thermoformable shell is accommodated between the labial, lingual and occlusal walls of the framework essentially and is anchored thereon by way of anchoring means which are formed in the framework and the thermoformable shell.

One hundred percent (100%) polyamide (“PA”) films and other rigid thermoplastic polyurethane (TPU) films have many physical properties which make them good candidates for dental aligners. For example, they have high initial force, high tensile modulus and good stress-relaxation properties which contribute to a “high work” aligner that can move the teeth in a quick and efficient manner.

However, there are various issues with aligners using these types of resin. For example, 100% PA films and other rigid TPU films can be difficult to process. Aligners made with these constituents can make an aligner stiff, which can lead to discomfort while installing and wearing the aligner.

Aligners made from these materials can be brittle, which can lead to cracking during the thermoforming and finishing processes of manufacturing the aligner.

To overcome these issues and other issues, invisible aligners herein are composed of a monolayer of rigid polyamide blended with elastomeric polyether block amide (PEBA) copolymer.

In embodiments, the rigid polyamide is PA-12. PA 12, also known as Nylon 12, is a good general-use plastic with broad additive applications. It is known for its toughness, tensile strength, impact strength and ability to flex without fracture. PA 12 has long been used by injection molders due to these mechanical properties.

In embodiments, the PA-12 is blended with the elastomeric PEBA copolymer, 3%-20% by weight. PEBA is a type of elastomeric nylon.

In embodiments, the rigid polyamide and elastomeric PEBA copolymer are medical grade resins with USP VI certification to insure bio-compatibility and ISO standard 10993-1 certification to insure biocompatibility of medical devices to manage biological risk.

The addition of the thermoplastic PEBA makes the resultant film more elastic, leading to higher tear strength, which improves cracking issues observed with standard rigid films.

The addition of softer elastomeric PEBA makes the resultant film comfortable to the wearer and retains high initial force/load and good stress-relaxation/creep.

Aligners made from rigid polyamide blended with elastomeric polyether block amide (PEBA) copolymer exhibit higher tear strength, which addresses current issues with cracking.

Aligners made from rigid polyamide blended with elastomeric polyether block amide (PEBA) copolymer thermoform without cracking like other rigid polyamides.

In embodiments, an aligner can be downgauged 15%-25% to deliver comparable performance to current commercial monolayer and multilayer dental aligners.

The addition of PEBA also enables improved bonding of soft PEBA skin(s) on either or both sides of the blended rigid PA-12 in extrusion lamination or coextrusion if desired for improved tooth movement or comfort via a multilayer construction.

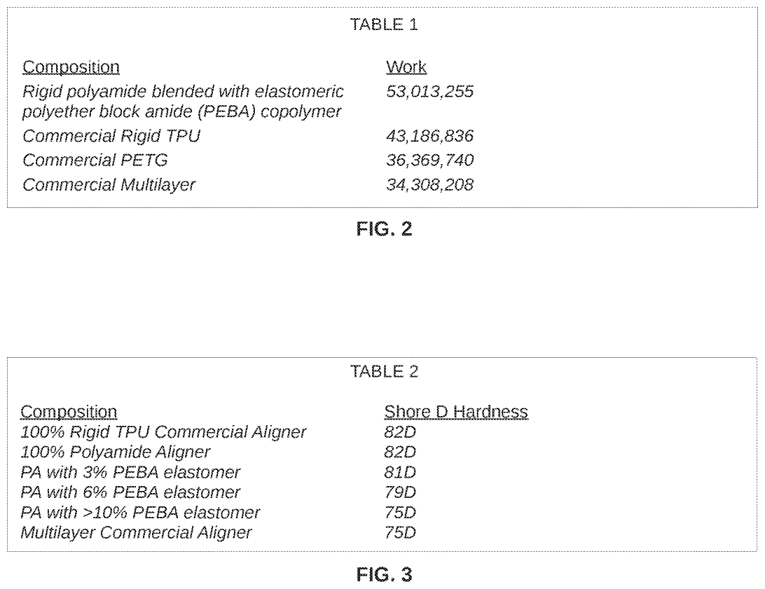

After a stress-relaxation test is performed, the area under a stress/strain curve can be measured and is one way of showing the amount of work being done by the dental aligner. As shown in Table 1 in FIG. 2, the present invention does 20-50% more work vs. commercial multilayer aligners.

Shore D Hardness is a standardized test involving measuring the depth of penetration of a specific indenter. Test methods used to measure Shore D Hardness are ASTM D2240 and ISO 868. The hardness value is determined by the penetration of a Durometer indenter foot into a sample. Shore Hardness measures are dimensionless. It goes between 0 and 100. The higher number represents the harder material. In other words, Shore D hardness is a test to determine how hard or soft a material is. The higher the value the harder the material. A softer material would give the user of the aligner a more comfortable experience. Table 2 in FIG. 3 illustrates exemplary Shore D hardness values for various dental aligner constituents.

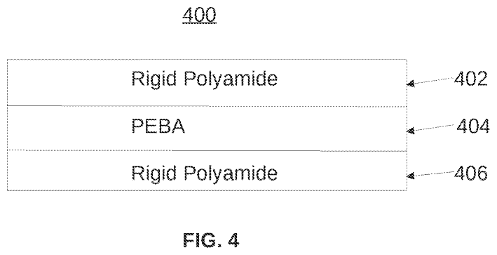

As shown in FIG. 4, an alternate embodiment of an invisible aligner 400 is composed of a rigid polyamide 402, a polyether block amide (PEBA) 404 and a rigid polyamide 406. In this embodiment, invisible aligner 400 includes a multilayer construction that uses 100% of each polymer in each individual layer.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

1. A composition comprising:
a monolayer of a rigid polyamide blended with elastomeric polyether block amide copolymer.

2. The composition of claim 1 wherein the rigid polyamide is PA-12 or Nylon 12.

3. The composition of claim 1, further comprising a polyether block amide (PEBA) layer; and/or a second rigid polyamide layer.

4. The composition of claim 1, further comprising a polyether block amide (PEBA) layer; and/or a second rigid polyamide layer and wherein the addition of the thermoplastic PEBA makes the resultant film more elastic, leading to higher tear strength, which improves cracking issues observed with standard rigid films.

5. The composition of claim 1, wherein the monolayer of the rigid PA-12 is blended with the elastomeric polyether block amide copolymer, 3%-20% by weight.

6. The composition of claim 1, wherein the composition is provided in a form of a dental aligner.

7. The composition of claim 1, further comprising a polyether block amide (PEBA) layer; and/or a second rigid polyamide layer and wherein the addition of the thermoplastic PEBA makes the resultant film more elastic, leading to higher tear strength, which improves cracking issues observed with standard rigid films; and wherein the composition is provided in a form of a dental aligner.

8. The composition of claim 1, further comprising the composition is provided in a form of a dental aligner including a framework made of a monolayer of a rigid polyamide blended with elastomeric polyether block amide copolymer, the framework having an anterior labial wall, and a posterior lingual wall, which walls are substantially parallel to each other and are connected by a bottom occlusal wall, the occlusal wall being substantially perpendicular to the labial and lingual walls in such a way that the framework has a U-shaped cross section in any vertical plane, wherein the shell is accommodated between the labial, lingual and occlusal walls of the framework, and wherein the shell is anchored thereon by way of anchoring means which are formed in the framework and the shell and having holes going therethrough from side to side between an internal surface of the occlusal wall on which rests the shell and an external surface of the occlusal wall.

9. A dental aligner comprising: a framework made of a monolayer of a rigid polyamide blended with elastomeric polyether block amide copolymer, the framework having an anterior labial wall, and a posterior lingual wall, which walls are substantially parallel to each other and are connected by a bottom occlusal wall, the occlusal wall being substantially perpendicular to the labial and lingual walls in such a way that the framework has a U-shaped cross section in any vertical plane, wherein the shell is accommodated between the labial, lingual and occlusal walls of the framework, and wherein the shell is anchored thereon by way of anchoring means which are formed in the framework and the shell and having holes going therethrough from side to side between an internal surface of the occlusal wall on which rests the shell and an external surface of the occlusal wall.

10. The dental aligner of claim 9, wherein the rigid polyamide is PA-12.

11. The dental aligner of claim 9, wherein the rigid polyamide is PA-12, and wherein the monolayer of the rigid PA-12 is blended with the elastomeric polyether block amide copolymer, 3%-20% by weight.

12. The dental aligner of claim 9, wherein the framework further comprises a skin of polyether block amide on a first side of the monolayer of the rigid polyamide blended with elastomeric polyether block amide copolymer.

13. The dental aligner of claim 9, wherein the framework is made of a first rigid polyamide layer, a polyether block amide (PEBA) layer, and a second rigid polyamide layer.

14. A dental aligner comprising a first softer layer operative to contact a subject's teeth after the aligner is placed on the subject's teeth and a second harder layer sandwiched between two layers of first layer, the second layer not in contact with the subject's teeth; wherein the dental aligner is one of a number of dental aligners planned for an orthodontic treatment of the subject to move the subject's teeth over a period of time to a corrected teeth position utilizing the number of aligners, the dental aligner including:
the first layer, wherein the first layer is operative to provide a softer and more comfortable layer against the subject's teeth than the second layer is capable of; and the first layer comprises a first thermoplastic material having a softer elastomeric PEBA making the resultant film comfortable to the wearer and retains high initial force/load and good stress-relaxation/creep; and wherein the material is transparent when viewed upon the subject's teeth;
the second layer, wherein the second layer is hard and comprises a second thermoplastic material having a hard PA-12 and/or PEBA containing layer and/or blends thereof, wherein the second layer is operative to provide a tooth moving force to move the subject's teeth and the material is transparent when viewed upon the subject's teeth; and
wherein the softer first layer when against the teeth is operative to provide a more compliant comfort to the subject and less pain to the subject when the number of dental aligners are placed on the subject's teeth over the period of time compared to a compliant comfort and a pain caused by a mono-hard-layer dental aligner or the sole second layer without the softer first layer when placed on the subject's teeth over the period of time.

15. The dental aligner of claim 14, wherein the rigid polyamide blended with elastomeric polyether block amide (PEBA) copolymer exhibit a high tear strength which prevents cracking of the dental aligner after being placed upon the subject's teeth.

16. The dental aligner of claim 14, wherein the thickness of the aligner is lowered to fit between one or more teeth and to deliver comparable performance to current commercial monolayer and multilayer dental aligners.

17. The dental aligner of claim 14, wherein the addition of PEBA and/or PA-12 to the second layer enables improved bonding of the first layer, which is comprising one or more soft PEBA skin(s) on either or both sides of a blended second layer including rigid PA-12 in extrusion lamination or coextrusion for improved tooth movement or comfort via a multilayer construction.

18. The dental aligner of claim 14, wherein after a stress-relaxation test is performed on the aligner, the area under a stress/strain curve can be measured and is one way of showing the amount of work being done by the dental aligner.

19. The dental aligner of claim 14, wherein after a stress-relaxation test is performed on the aligner, the area under a stress/strain curve can be measured and is one way of showing the amount of work being done by the dental aligner; and wherein the dental aligner does 20-50% more work when compared to commercial multilayer aligners.

20. The dental aligner of claim 14, wherein the softer first layer against the teeth is operative to provide 1a) a more effective force transmission to the subject's teeth, 2a) a less treatment time required to provide a movement of the subject's tooth or teeth, 3a) a lower number of dental aligners required to provide a movement of the subject's teeth for the orthodontic treatment of the subject, and 4a) an improved creep reduction in the dental aligner compared to 1b) a force transmission to the subject's teeth by a dental aligner without the softer first layer, 2b) a time required to provide a movement of the subject's tooth or teeth by a dental aligner without the softer first layer, 3b) a number of dental aligners without the softer first layer required to provide a movement of the subject's teeth for the orthodontic treatment of the subject, and 4b) an amount of creep caused by a dental aligner without the softer first layer placed in contact with the subject's teeth.
